(19) United States
(12) Patent Application Publication
(10) Pub. No.: US 2003/0029359 A1
(43) Pub. Date: Feb. 13, 2003

(54) Plastics dispersible pigments and processes for preparing the same

(76) Inventors: David Marshall, Edmond, OK (US); Sarah Staton, Stillwater, OK (US); Dana King, Edmond, OK (US); Keven Stone, Meeker, OK (US)

Correspondence Address: McAfee & Taft, Two Leadership Square, 10th Floor, 211 N. Robinson, Oklahoma City, OK, 73102, US

(21) Appl. No.: 09/872,950

(22) Filed: Jun. 1, 2001

(51) Int. Cl. C09C 1/00; C09C 1/36

(52) U.S. Cl. 106/504; 106/447

(57) ABSTRACT

Improved particulate inorganic pigments and processes for preparing such inorganic pigments which have enhanced dispersibility in plastic materials are provided. The processes basically comprise coating the particulate inorganic pigment with a dispersibility improving agent comprised of a complex mixture of partially and totally polysaturated and unsaturated fatty acid esters and derivatives thereof.

### BACKGROUND OF THE INVENTION

1. Field of the Invention

The present invention relates to improved particulate inorganic pigments having enhanced dispersibility in plastics and processes for preparing such pigments.

2. Description of the Prior Art

Inorganic pigments are generally utilized in the form of finely divided powders which have been jet-milled or micronized as a final step in their production. Examples of such particulate inorganic pigments which are commonly used in plastic materials include, but are not limited to, titanium dioxide, zinc sulfide, zinc oxide, iron oxide, lead oxide, aluminum oxide, silicon dioxide, zirconium oxide and chromium oxide. However, such pigments have heretofore been difficult to disperse in plastic materials. That is, the particulate inorganic pigments have required long periods of time and/or high levels of energy to achieve optimism dispersal in plastic materials.

Various processes have been developed and used for preparing particulate inorganic pigments which require less energy to disperse in plastic materials. For example, U.S. Pat. No. 4,061,503 issued to Berger et al. on Dec. 7, 1977 and U.S. Pat. No. 4,151,154 issued to Berger on Apr. 24, 1979 disclosed the treatment of particulate pigment surfaces with a polyether substituted silicon compound which serves to enhance its employment in pigmented paints and plastics. U.S. Pat. No. 4,810,305 issued to Braun et al. on Mar. 7, 1989 discloses a hydrophobic pigment or filler containing an organopolysiloxane which has improved dispersion properties. U.S. Pat. No. 5,733,365 issued to Halko et al. on Mar. 31, 1998 and its related U.S. Pat. No. 5,908,498 issued to Kaufman et al. on Jun. 1, 1999 disclose a process for preparing inorganic pigments having enhanced dispersibility in paints and plastics. The inorganic pigments are treated with an agent having the formula ROOCCHSO₃MCH₂COOR¹ wherein R and R¹ are monovalent alkyl radicals having from about 2 to about 20 carbon atoms and M is a metallic monovalent cation.

While the treated pigments produced in accordance with the teachings of the above described patents constitute improvements as compared to prior pigments, the dispersal of the pigments in plastic materials still requires considerable mixing time, energy and expense. Thus, there are continuing needs for improved plastics dispersible pigments and processes for preparing such pigments.

### SUMMARY OF THE INVENTION

The present invention provides improved particulate inorganic pigments having enhanced dispersibility and processes for producing such pigments. The improved particulate inorganic pigments of this invention are processed whereby a coating of a dispersibility improving agent is formed thereon. The dispersion improving agent is comprised of a complex mixture of partially or totally polysaturated and unsaturated fatty acid esters and derivatives thereof, the fatty acid esters having the formula RCOOR¹ wherein R and R¹ each have in the range of from 10 to 24 carbon atoms. The resulting coated particulate organic pigments have enhanced dispersibility in plastic materials.

A process for preparing the improved particulate inorganic pigments which have enhanced dispersibility in plastic materials is comprised of the following steps: (a) mixing a non-micronized particulate inorganic pigment with water to form a slurry of the pigment and water; (b) milling the slurry formed in step (a) to produce a pigment particle size in the range of from about 0.1 micron to about 1 micron; (c) combining with the slurry a dispersibility improving agent so that the particulate inorganic pigment is coated therewith, the dispersibility improving agent being comprised of a complex mixture of partially and totally polysaturated and unsaturated fatty acid esters and derivatives thereof, the fatty acid esters having the formula RCOOR¹ wherein R and R¹ each have in the range of from 10 to 24 carbon atoms; and (d) separating the coated particulate inorganic pigment from the slurry and drying the pigment.

Another process of this invention for preparing an improved particulate organic pigment which has enhanced dispersibility in plastic materials is comprised of the steps of: (a) mixing a non-micronized particulate inorganic pigment with water to form a slurry of the pigment and water; (b) sand milling the slurry formed in step (a) to produce a pigment particle size in the range of from about 0.1 micron to about 1 micron; (c) separating the particulate inorganic pigment from the slurry and drying the pigment; (d) mixing with the dried particulate inorganic pigment a dispersibility improving agent comprised of a complex mixture of partially and totally polysaturated and unsaturated fatty acid esters and derivatives thereof, the fatty acid esters having the formula RCOOR¹ wherein R and R¹ each have in the range of from 10 to 24 carbon atoms; and (e) micronizing the mixture of particulate inorganic pigment and the dispersibility improving agent with superheated steam so that the particulate inorganic pigment is micronized and coated with the dispersibility improving agent.

It is, therefore, a general object of the present invention to provide improved particulate inorganic pigments which are more readily dispersible in plastics materials and processes for preparing such improved pigments.

Other and further objects, features and advantages of the present invention will be readily apparent to those skilled in the art upon a reading of the description of preferred embodiments which follows.

### DESCRIPTION OF PREFERRED EMBODIMENTS

A variety of particulate inorganic pigments have heretofore been utilized in plastic materials. Examples of such pigments include, but are not limited to, titanium dioxide, zinc sulfide, zinc oxide, iron oxide, lead oxide, aluminum oxide, silicon dioxide, zirconium oxide and chromium oxide. The most preferred particulate inorganic pigment utilized for use in accordance with this invention is titanium dioxide.

The improved particulate inorganic pigments produced by the processes of the present invention are more readily dispersed in plastic materials and generally require less time and/or energy to disperse than prior art pigments. More specifically, as compared to prior art particulate inorganic pigments, when the improved particulate inorganic pigments of this invention are dispersed in plastic materials, they require reduced power consumption, reduced melt temperature and reduced pressure. In addition, the inorganic pigments of this invention have improved retention of flow properties, improved ultraviolet yellowing resistance and other properties in the plastic product produced therefrom and improved lacing resistance in the product.

The improved particulate inorganic pigment of this invention which has enhanced dispersibility in plastic materials is basically comprised of a particulate inorganic pigment having a coating of a dispersibility improving agent thereon comprised of a complex mixture of partially and totally polysaturated and unsaturated fatty acid esters and derivatives thereof, the fatty acid esters having the formula RCOOR¹ wherein R and R¹ each have in the range of from 10 to 24 carbon atoms.

The pigment utilized in the products and processes of this invention is preferably a particulate inorganic pigment with a primary particle size in the range of from about 0.1 micron to 1.0 micron, preferably about 0.2 micron. When the particulate inorganic pigment is the preferred titanium dioxide pigment, the titanium dioxide is preferably of the rutile crystalline structure and contains co-oxidized alumina in an amount in the range of from about 0.5% to about 1.5% by weight, most preferably from about 1.2% to about 1.5%. The titanium dioxide can be produced by well known commercial processes such as the vapor phase chloride oxidation process or the sulfate process.

The dispersibility improving agent utilized in accordance with this invention is comprised of a complex mixture of partially and totally polysaturated and unsaturated fatty acid esters and derivatives thereof, the fatty acid esters having the formula RCOOR¹ wherein R and R¹ each have in the range of from 10 to 24 carbon atoms.

A preferred process of the present invention for preparing an improved particulate inorganic pigment of this invention which has enhanced dispersibility in plastic materials is comprised of the following steps. A particulate inorganic pigment, preferably particulate rutile titanium dioxide pigment containing co-oxidized alumina in an amount in the range of from about 1.2% to about 1.5% by weight, having a primary particle size in the range of from about 0.1 micron to about 1.0 micron, preferably about 0.2 micron, is mixed with water and a dispersing agent to form a slurry of the pigment and water. The slurry generally contains the particulate inorganic pigment in an amount in the range of from about 10% to about 50% by weight of the slurry, preferably in an amount in the range of from about 20% to about 40% and most preferably about 30%. The slurry is generally formed at a temperature in the range of from about 10° C. to about 90° C., preferably from about 15° C. to about 80° C. and most preferably at a temperature of about 25° C. The slurry generally contains the dispersing agent in an amount in the range of from about 0.1% to about 0.4% by weight of the slurry, preferably 0.15%. Dispersing agents that can be used include, but are not limited to, tetrasodium diphosphate or sodium hexametaphosphate.

When the particulate pigment-water slurry is formed, the pigment agglomerates and the viscosity of the slurry increases. The pH of the slurry can be adjusted to reduce its viscosity, if necessary, to a pH in the general range of from about 7 to about 13, more preferably a pH of from about 8 to about 11 and most preferably about 9.5.

The slurry is next sandmilled to produce a pigment particle size in the range of from about 0.1 micron to about 1.0 micron, preferably a pigment particle size wherein from about 50% to about 100% of the particles are smaller than 0.63 micron as measured by a Microtrac ×100 particle size analyzer, and most preferably wherein from about 80% to about 95% of the particles are smaller than 0.63 micron. While a variety of milling apparatus can be utilized, a sand mill is preferred.

After the slurry is milled, the pH can be adjusted to a range of from about 1 to about 3, preferably a pH of 3, with an acid such as sulfuric acid followed by increasing the pH to a range of from about 6 to about 9, preferably a pH of 7, with a base such as sodium hydroxide to flocculate the pigment prior to washing and filtering the slurry. After the pH adjustments are made, the slurry can be filtered and the filter cake washed to remove impurities and to increase the pigment content of the slurry to in the range of from about 40% to about 75% solids.

A dispersibility improving agent is next added to the slurry so that the particulate inorganic pigment is coated therewith. The dispersibility improving agent is comprised of a complex mixture of partially and totally polysaturated and unsaturated fatty acid esters and derivatives thereof as described above. The dispersibility improving agent is preferably added to the slurry in a water based emulsion form and is generally mixed with the slurry in an amount in the range of from about 0.5% to about 1.5% by weight of the particulate inorganic pigment in the slurry. The mixing of the dispersibility improving agent with the slurry can be carried out in a time period in the range of from about 1 minute to about 24 hours, preferably in a time period from about 1 minute to about 10 minutes and most preferably in a time period of about 5 minutes. The dispersibility improving agent is generally coated on the particulate inorganic pigment in an amount in the range of from 0.5% to about 1.5% by weight of the pigment.

After being coated with the dispersibility improving agent, the coated particulated inorganic pigment is separated from the slurry and dried. The separation and drying of the coated pigment is preferably carried out by spray drying the pigment. However, other separating and drying equipment can be utilized such as tunnel dryers, spin flash dryers, fluid bed dryers and the like. After being separated and dried, the dried coated pigment can be micronized if desired.

Another preferred process of the present invention for preparing an improved particulate inorganic pigment of this invention which has enhanced dispersibility in plastic materials is comprised of the following steps. A particulate inorganic pigment, preferably particulate rutile titanium dioxide pigment containing co-oxidized alumina in an amount in the range of from about 1.2% to about 1.5% by weight, having a primary particle size in the range of from about 0.1 micron to about 1.0 micron, most preferably about 0.2 micron, is mixed with water and a dispersing agent of the type described above to form a slurry of the pigment and water. The slurry generally contains the particulate inorganic pigment in an amount in the range of from about 10% to about 50% by weight of the slurry, preferably in an amount in the range of from about 20% to about 40% and most preferably about 30%. The slurry is generally formed at a temperature in the range of from about 10° C. to about 90° C., preferably from about 15° C. to about 80° C. and most preferably at a temperature of about 25° C. The slurry generally contains from about 0.1% to about 0.4% of the dispersing agent, preferably about 0.15%.

As mentioned above, when the slurry is formed, the pigment agglomerates and the viscosity of the slurry increases. The pH of the slurry can be adjusted to reduce the viscosity, if necessary, to a pH in the general range of from about 7 to about 13, more preferably a pH of from about 8 to about 11 and most preferably about 9.5.

The slurry is sand milled to produce a pigment particle size in the range of from about 0.1 micron to about 1.0 micron, preferably a pigment particle size wherein from about 50% to about 100% of the particles are smaller than 0.63 micron as measured by a Microtrac ×100 particle size analyzer, and most preferably wherein from about 80% to 95% of the particles are smaller than 0.63 micron. While a variety of milling apparatus can be utilized, a sand mill is preferred.

After the slurry is milled, the pH can be adjusted to a range of from about 1 to about 3, preferably a pH of 3, with an acid such as sulfuric acid followed by increasing the pH to a range of from about 6 to about 9, preferably a pH of 7, with a base such as sodium hydroxide to flocculate the pigment prior to washing and filtering the slurry. After the pH adjustments are made, the slurry can be filtered and the filter cake washed to remove impurities and to increase the pigment content of the slurry to in the range of from about 40% to about 75% solids.

The particulate inorganic pigment is next separated from the slurry and dried. Thereafter, the dried particulate inorganic pigment is mixed with the dispersibility improving agent described above comprised of a complex mixture of partially and totally polysaturated and unsaturated fatty acid esters and derivatives thereof. When the dispersibility improving agent is mixed with the dried particulate inorganic pigment as described above, it is preferably added to the dried pigment in dry powder form. The mixture of the dried pigment and dispersibility improving agent powder is next micronized with superheated steam so that the particulate inorganic pigment is micronized and coated with the dispersibility improving agent.

In both of the processes described above, a chemical additive for improving the flow characteristics of the particulate inorganic pigment during drying can be combined with the slurry prior to when the particulate inorganic pigment is separated from the slurry and dried. The chemical additive is preferably selected from the group consisting of polyalcohols, alkanolamines or organophosphates. When used, the chemical additive is combined with the slurry in an amount in the range of from about 0.1% to about 4% by weight of the particulate inorganic pigment in the slurry, preferably in an amount of about 0.35%. The chemical additive utilized is preferably mixed with the slurry for a time period in the range of from about 1 minute to about 24 hours, preferably in the range of from about 1 minute to about 10 minutes.

Also, in both of the processes described above, the particulate inorganic pigment can be coated with a metal oxide after the slurry of the pigment is formed. Metal oxides which can be used include, but are not limited to, aluminum oxide, silicon oxide and zirconium oxide with aluminum oxide being preferred. Such coating improves the pigmentary properties of the pigment product and are well known to those skilled in the art.

Thus, a preferred process of the present invention for preparing an improved particulate inorganic pigment which has enhanced dispersibility in plastic materials comprises the steps of: (a) mixing a particulate inorganic pigment with water to form a slurry of the pigment and water; (b) milling the slurry formed in step (a) to produce a pigment particle size in the range of from about 0.1 micron to about 1 micron; (c) combining with the slurry a dispersibility improving agent so that the particulate inorganic pigment is coated therewith, the dispersibility improving agent being comprised of a complex mixture of partially and totally polysaturated and unsaturated fatty acid esters and derivatives thereof, the fatty acid esters having the formula RCOOR¹ wherein R and R¹ each have in the range of from 10 to 24 carbon atoms; and (d) separating the coated particulate inorganic pigment from the slurry and drying the pigment.

Another preferred process of this invention for preparing an improved particulate inorganic pigment which has an enhanced dispersibility in plastic materials comprises the steps of: (a) mixing a particulate inorganic pigment with water to form a slurry of the pigment and water; (b) sand milling the slurry formed in step (a) to produce a pigment particle size in the range of from about 0.1 micron to about 1 micron; (c) separating the particulate inorganic pigment from the slurry and drying the pigment; (d) mixing with the dried particulate inorganic pigment a dispersibility improving agent comprised of a complex mixture of partially and totally polysaturated and unsaturated fatty acid esters and derivatives thereof, the fatty acid esters having the formula RCOOR¹ wherein R and R¹ each have in the range of from 10 to 24 carbon atoms; and (e) micronizing the mixture of particulate inorganic pigment and the dispersibility improving agent with superheated steam so that the particulate inorganic pigment is micronized and coated with the dispersibility improving agent.

The improved particulate inorganic pigment of this invention having enhanced dispersibility in plastic materials basically comprises a particulate inorganic pigment coated with a dispersibility improving agent comprised of a complex mixture of partially or totally polysaturated and unsaturated fatty acid esters and derivatives thereof, the fatty acid esters having the formula RCOOR¹ wherein R and R¹ each have in the range of from 10 to 24 carbon atoms.

As mentioned above, the inorganic pigment utilized in forming the improved particulate inorganic pigment of this invention can be any one of a large number of particulate inorganic pigments which have been utilized heretofore in paints and plastic materials. Preferably, the particulate inorganic pigment is selected from the group of titanium dioxide, zinc sulfide, zinc oxide, iron oxide, lead oxide, aluminum oxide, silicon dioxide, zirconium oxide and chromium oxide. As also mentioned the inorganic pigment is preferably particulate titanium dioxide pigment. The improved particulate inorganic pigment of this invention includes the dispersibility improving agent coated thereon in an amount in the range of from about 0.5% to about 1.5% by weight of the pigment.

In order to further illustrate the improved plastics dispersible pigment and process for preparing the pigment, the following examples are given.

### EXAMPLE 1

A particulate rutile titanium dioxide pigment with 1.2% lattice alumina formed by the chloride process was mixed with water and a dispersant of 0.15% tetrasodium diphosphate to form a slurry containing about 30% particulate titanium dioxide pigment by weight of the slurry. The slurry was sand milled until about 85% of the pigment particles were smaller than about 0.63 microns in diameter as measured by the Microtrac ×100 Particle Size Analyzer. The slurry was washed and filtered with rotary drum filters to remove soluble salts therefrom and trimethylolpropane was added to the washed and filtered slurry in an amount of about 0.35% by weight of the titanium dioxide pigment in the slurry to improve the flow characteristics of the pigment during drying. The particulate titanium dioxide pigment was dried in a spray dryer. The dried particulate titanium dioxide pigment was then mixed with the dispersibility improving agent utilized in accordance with this invention in powder form. The mixture contained the dispersibility improving agent in an amount of about 0.65% by weight of the particulate titanium dioxide pigment in the mixture. Thereafter, the mixture was micronized with superheated steam. The resulting coated titanium dioxide pigment produced is referred to hereinafter as “Pigment A.”

A variety of comparative particulate titanium dioxide pigments were obtained or produced as follows:

Comparative Pigment B

A particulate titanium dioxide pigment produced by the chloride process was obtained from Millenium Chemicals, Inc. of Redbank, N.J. sold under the trade designation “RCL-188™.”

Comparative Pigment C

A sample of a particulate titanium dioxide pigment was obtained from the E. I. DuPont de Nemours and Company, of Wilmington, Del. sold under the trade designation “R-104™.”

Comparative Pigment D

A sample of a particulate titanium dioxide pigment produced by the chloride process was obtained from Kronos, Inc. of Cranbury, N.J. sold under the trade designation “KR-2073™.”

Comparative Pigment E

Rutile titanium dioxide produced by the chloride process described in Pigment A above was micronized with superheated steam without being treated with the dispersibility improving agent of this invention.

Comparative Pigment F

Rutile titanium dioxide produced by the chloride process described in Pigment A above was used except that polydimethylsiloxane (PDMS) instead of trimethylolpropane (TMP) was added to the slurry so that the pigment was coated therewith and the pigment was not treated with the dispersibility improving agent of this invention. The slurry containing the pigment was spray dried and the dry pigment was then micronized with superheated steam.

Comparative Pigment G

A slurry of rutile titanium dioxide produced by the sulfate process was prepared according to the methods well known to those skilled in the art, methyl hydrogen polysiloxane was utilized to form a coating on sulfate titanium dioxide in an amount of 0.5% by weight of the titanium dioxide. The dry coated titanium dioxide was micronized with superheated steam.

Pigment A and Comparative Pigments B through G were each mixed with a low density polyethylene having a melt flow index of 15 as follows. Dry mixtures of each pigment with the low density polyethylene were prepared containing 75% by weight pigment and 25% by weight polyethylene. Each of the dry mixtures were added to a preheated bowl of a Brabender Torque Rheometer. The Brabender Torque Rheometer was equipped to measure the torque in meter-grams throughout the mixing process. The final equilibrium torque of the system was recorded for comparison between test samples. The final equilibrium torque was recorded for comparison between test samples and is a measure of the relative state of dispersion in the polyethylene matrix. After the final equilibrium torque of a sample was recorded, the sample was discharged from the mixer, cooled and tested for melt flow index. The melt flow index was determined using a Tinius Melt Indexer at 190° C. and a 10 kg weight. The results of these tests are given in Table I below.

TABLE I
Equilibrium Torque And Melt Flow Index Tests

| Test | Test Sample | Equilibrium Torque, | Melt Flow |
|---|---|---|---|
| No. | Pigment | meter-grams | Index |
| 1 | Pigment A | 936 | 12.8 |
| 2 | Comparative Pigment B | 952 | 6.0 |
| 3 | Comparative Pigment C | 1140 | 4.4 |
| 4 | Comparative Pigment D | 1180 | 3.0 |
| 5 | Comparative Pigment E | 1183 | 1.8 |
| 6 | Comparative Pigment F | 1206 | 6.5 |
| 7 | Comparative Pigment G | 1251 | 3.6 |

From Table I, it can be seen that Pigment A was mixed with the polyethylene at a lower equilibrium torque than any of the Comparative Pigments. Also, it can be seen that the mixture of Pigment A and the polyethylene had a higher melt flow index than any of the mixtures including the Comparative Pigments. The mixture of Pigment A with the polyethylene lowered the melt flow index of the mixture as compared to the pure polyethylene a relatively small amount.

### EXAMPLE 2

In this example, Pigment A and Comparative Pigments B through G were mixed with a low density polyethylene in a ratio of 75 weight percent pigment and 25 weight percent polyethylene and then extruded using a Farrel FTX-80 Twin Screw Extruder. The particulate pigment and the low density polyethylene which had a 22 melt flow index were metered into the feed hopper of the extruder. The extruder was configured with ten 4 L/D barrel sections. The feed barrel was water-cooled while the remaining barrels were temperature controlled with electric heat and water cooling. A 6-hole strand die head with 3.18 millimeter diameter holes discharged extruded mixture into a water bath. The extruder was operated at three constant production rates while the power consumption, melt temperature, and head pressure were recorded. The three production rates were 400, 600 and 700 pounds per hour. The melt temperature, power consumption and head pressure were all measured by instruments associated with the extruder. However, because of problems in loading the pigment and polymer into the extruder, the maximum rates for Comparative Pigment D, Comparative Pigment E and Comparative Pigment F were 600 pounds per hour, and the maximum rate for Comparative Pigment G was 500 pounds per hour. The averages given in Table II below include only the above actual achievable rates.

The same tests as described above were also conducted utilizing a Farrel CP-500 continuous mixer which discharged into an extruder equipped with a die face cutter. The two components tested, i.e., Pigment A or one of Comparative Pigments B through G and 22 melt flow index low density polyethylene were discharged into the feed hopper for the mixer. The mixer was operated at three constant production rates, i.e., 750, 1,000 and 1,250 pounds per hour, while the power consumption, melt temperature and head pressure were recorded. The data presented in Table II below is an average of the three production rates except that Comparative Pigment F was not able to achieve the 1,250 pound per hour rate and the average presented for Comparative Pigment F is only for the 750 and 1,000 pound per hour rates.

Samples of the extruded test mixtures described above were remelted and run through a Leistritz extruder which was equipped with a 500 mesh screen positioned between two 20 mesh screens. The screen pack residue formed was collected and the pigment content thereof was evaluated to determine the quality of the dispersion of the pigment into the polyethylene. Portions of the remelted samples were used for determining the melt flow index values of the samples.

The results of the tests using the Farrel FTX-80 twin screw extruder, the Farrel CP-500 continuous mixer and the Leistritz extruder are set forth in Table II below.

TABLE II
Test Results Using A Farrel FTX-80 Extruder And A Farrel CP-500 Continuous Mixer-Extruder

| | | CP 500 Mixer-Extruder | | | | | FTX-80 Extruder | | | | |
|---|---|---|---|---|---|---|---|---|---|---|---|
| | | Average | Average | Average | | Screen Pack | Average | Average | Average | | Screen Pack |
| | Test | Power | Melt | Head | Melt | Residue | Power | Mixer | Head | Melt | Residue |
| Test | Sample | Input, | Temp., | Pressure, | Flow | Pigment | Input, | Melt | Pressure, | Flow | Pigment |
| No. | Pigment | Hp-hr/lb | ° C. | psi | Index | Content, ppm | Hp-hr/lb | Temp., ° C. | psi | Index | Content, ppm |
| 1 | Pigment A | 0.0525 | 393 | 553 | 6.1 | 120 | 0.065 | 461 | 646 | 9.6 | 115 |
| 2 | Comparative | 0.0580 | 408 | 861 | 4.3 | — | 0.064 | 466 | 707 | 4.9 | 81 |
| | Pigment B | | | | | | | | | | |
| 3 | Comparative | 0.0630 | 473 | 995 | 0 | 138 | 0.072 | 482 | 794 | 4.3 | 162 |
| | Pigment C | | | | | | | | | | |
| 4 | Comparative | 0.0640 | 400 | 836 | 9.2 | — | 0.073 | 484 | 812 | 2.1 | 970 |
| | Pigment D | | | | | | | | | | |
| 5 | Comparative | 0.0610 | 455 | 773 | 1.2 | 139 | 0.072 | 485 | 776 | 0 | 3750 |
| | Pigment E | | | | | | | | | | |
| 6 | Comparative | 0.0631 | 447 | 907 | 1.2 | 230 | 0.066 | 481 | 818 | 3.6 | 242 |
| | Pigment F | | | | | | | | | | |
| 7 | Comparative | 0.0643 | 461 | 864 | 0.8 | 458 | 0.069 | 481 | 757 | 4.4 | 1708 |
| | Pigment G | | | | | | | | | | |

From Table II above, it can be seen that the improved pigment of the present invention (Pigment A) is more readily dispersed in plastic materials and generally requires less time and/or energy to disperse than prior art pigments.

### EXAMPLE 3

Injection molded plaques containing 2.6 weight percent of the improved particulate titanium dioxide pigment of this invention, 0.3 weight percent 2,6-Di-tertbutyl-4-methylphenol (BHT), 0.3 weight percent of an ultraviolet stabilizer Bis(2,2,6,6-tetramethyl-4-piperidy) sebacate (TINUVIN 770) and 96.8 weight percent low density polyethylene were prepared and tested for BHT stability. The b values (yellow/blue color index) of the plaques were recorded prior to subjecting the plaques to ultraviolet and moisture exposure for 96 hours. After the 96 hours, the b values were again recorded and the difference in the b values (delta b) were determined. The exposure to ultraviolet light and moisture accelerates the yellowing of the plaques.

Portions of the extrudate produced by the FTX-80 extruder comprised of 70% by weight particulate titanium dioxide pigment and 25% by weight low density polyethylene prepared in Example 1 were subjected to Thermal Gravimetric Analysis (TGA), i.e., a method of determining the resistance to lacing. That is, the weight loss data between 150° C. and 350° C. was recorded and the parts per million weight loss per degree C was calculated. The results of these tests are set forth in Table III below.

TABLE III
BHT Stability And Thermal Gravimetric Analysis (TGA) Tests

| Test | Test Sample | BHT Stability, | TGA, |
|---|---|---|---|
| No. | Pigment | 96 hour delta b¹ | ppm wt. loss/° C. |
| 1 | Pigment A | 4.7 | 100 |
| 2 | Comparative Pigment B | 4.9 | 114 |
| 3 | Comparative Pigment C | 6.9 | 100 |
| 4 | Comparative Pigment D | 3.8 | 123 |
| 5 | Comparative Pigment E | 6.8 | 209 |
| 6 | Comparative Pigment F | — | 158 |
| 7 | Comparative Pigment G | — | 211 |

¹Higher values indicate increased yellowing and decreased BHT stability.

From Table III, it can be seen that the improved pigment of the present invention provides improved BHT stability and improved lacing resistance as compared to most of the comparative pigments.

### EXAMPLE 4

Injection molded plaques containing 5 weight percent of Pigment A and 5 weight percent of each of the Comparative Pigments B-G and low density polyethylene were prepared over a temperature range of 410° F. to 675° F. The initial b value was recorded at 410° F. and the delta b values were calculated from the b readings over the temperature range. The results of these tests are given in Table IV below.

TABLE IV
Thermal Yellowing Tests

| Test | | Delta b Values Over Temperature Range | | | | | | |
|---|---|---|---|---|---|---|---|---|
| No. | Test Sample Pigment | 460° F. | 510° F. | 560° F. | 610° F. | 635° F. | 660° F. | 675° F. |
| 1 | Pigment A | 0.11 | 0.27 | 0.73 | 1.40 | 1.74 | 2.23 | 2.47 |
| 2 | Comparative | 0.17 | 0.31 | 0.89 | 0.98 | 1.42 | 2.27 | 2.56 |
| | Pigment B | | | | | | | |
| 3 | Comparative | 0.15 | 0.24 | 0.31 | 1.05 | 1.53 | 1.45 | 1.34 |
| | Pigment C | | | | | | | |
| 4 | Comparative | 0.34 | 0.58 | 1.29 | 2.28 | 2.58 | 2.88 | 3.04 |
| | Pigment D | | | | | | | |
| 5 | Comparative | 0.23 | 0.34 | 0.85 | 2.53 | 2.59 | 2.96 | 3.12 |
| | Pigment E | | | | | | | |

From Table IV, it can be seen that the improved pigment of this invention (Pigment A) provides improvement in thermal yellowing.

Thus, the present invention is well adapted to carry out the objects and attain the ends and advantages mentioned as well as those which are inherent therein. While numerous changes may be made by those skilled in the art, such changes are encompassed within the spirit of this invention as defined by the appended claims.

What is claimed is:

1. In a process for preparing a particulate inorganic pigment, the improvement whereby said pigment has enhanced dispersibility in plastic materials which comprises:
coating said particulate inorganic pigment with a dispersibility improving agent comprised of a complex mixture of partially and totally polysaturated and unsaturated fatty acid esters and derivatives thereof, said fatty acid esters having the formula RCOOR¹ wherein R and R¹ each have in the range of from 10 to 24 carbon atoms.

2. The process of claim 1 wherein said particulate inorganic pigment is particulate rutile titanium dioxide pigment.

3. The process of claim 2 wherein said particulate titanium dioxide pigment contains co-oxidized alumina in an amount in the range of from about 0.5% to about 1.5% and has a primary particle size in the range of from about 0.1 micron to about 1.0 micron.

4. The process of claim 1 wherein said particulate inorganic pigment includes a coating of a metal oxide thereon.

5. The process of claim 1 wherein said dispersibility improving agent is coated on said particulate inorganic pigment in an amount in the range of from about 0.5% to about 1.5% by weight of said pigment.

6. A process for preparing an improved particulate inorganic pigment which has enhanced dispersibility in plastic materials comprising the steps of:
(a) mixing a particulate inorganic pigment with water to form a slurry of said pigment and water;
(b) milling the slurry formed in step (a) to produce a pigment particle size in the range of from about 0.1 micron to about 1 micron;
(c) combining with said slurry a dispersibility improving agent so that said particulate inorganic pigment is coated therewith, said dispersibility improving agent being comprised of a complex mixture of partially and totally polysaturated and unsaturated fatty acid esters and derivatives thereof, said fatty acid esters having the formula RCOOR¹ wherein R and R¹ each have in the range of from 10 to 24 carbon atoms; and
(d) separating said coated particulate inorganic pigment from said slurry and drying said pigment.

7. The process of claim 6 wherein said particulate inorganic pigment is particulate rutile titanium dioxide pigment.

8. The process of claim 7 wherein said particulate titanium dioxide pigment contains co-oxidized alumina in an amount in the range of from about 0.5% to about 1.5% and has a primary particle size in the range of from about 0.1 micron to about 1.0 micron.

9. The process of claim 6 which further comprises the step of adjusting the pH of said slurry to reduce the viscosity thereof after forming said slurry in accordance with step (a).

10. The process of claim 6 which further comprises the step of coating said particulate inorganic pigment with a metal oxide after forming the slurry in accordance with step (a).

11. The process of claim 6 wherein said slurry formed in step (a) contains said particulate inorganic pigment in an amount in the range of from about 10% to about 50% by weight of said slurry.

12. The process of claim 6 wherein said slurry formed in step (a) is at a temperature in the range of from about 10° C. to about 90° C.

13. The process of claim 6 which further comprises the steps of adjusting the pH of said slurry, filtering said slurry and washing the filter cake after milling said slurry in accordance with step (b).

14. The process of claim 6 wherein said dispersibility improving agent is in the form of a water based liquid emulsion and is combined with said slurry in accordance with step (c) in an active amount in the range of from about 0.5% to about 1.5% by weight of said particulate inorganic pigment in said slurry.

15. The process of claim 6 wherein said dispersibility improving agent is coated on said particulate inorganic pigment in accordance with step (c) in an amount in the range of from about 0.5% to about 1.5% by weight of said pigment.

16. The process of claim 6 which further comprises the step of combining a chemical additive for improving the flow characteristics of said particulate inorganic pigment during drying with said slurry prior to drying said pigment in accordance with step (d).

17. The process of claim 6 wherein said particulate inorganic pigment is separated from said slurry and dried in accordance with step (d) by spray drying said pigment.

18. The process of claim 6 which further comprises micronizing said dried pigment.

19. A process for preparing an improved particulate inorganic pigment which has an enhanced dispersibility in plastic materials comprising the steps of:
(a) mixing a particulate inorganic pigment with water to form a slurry of said pigment and water;
(b) sand milling the slurry formed in step (a) to produce a pigment particle size in the range of from about 0.1 micron to about 1 micron;
(c) separating said particulate inorganic pigment from said slurry and drying said pigment;
(d) mixing with said dried particulate inorganic pigment a dispersibility improving agent comprised of a complex mixture of partially and totally polysaturated and unsaturated fatty acid esters and derivatives thereof, said fatty acid esters having the formula RCOOR¹ wherein R and R¹ each have in the range of from 10 to 24 carbon atoms; and
(e) micronizing said mixture of particulate inorganic pigment and said dispersibility improving agent with superheated steam so that said particulate inorganic pigment is micronized and coated with said dispersibility improving agent.

20. The process of claim 19 wherein said particulate inorganic pigment is particulate rutile titanium dioxide pigment.

21. The process of claim 20 wherein said particulate titanium dioxide pigment contains co-oxidized alumina in an amount in the range of from about 0.5% to about 1.5% and has a primary particle size in the range of from about 0.1 micron to about 1.0 micron.

22. The process of claim 19 which further comprises the step of adjusting the pH of said slurry to reduce the viscosity thereof after forming said slurry in accordance with step (a).

23. The process of claim 19 which further comprises the step of coating said particulate inorganic pigment with a metal oxide after forming the slurry in accordance with step (a).

24. The process of claim 19 wherein said slurry formed in step (a) contains said particulate inorganic pigment in an amount in the range of from about 10% to about 50% by weight of said slurry.

25. The process of claim 19 wherein said slurry formed in step (a) is at a temperature in the range of from about 10° C. to about 90° C.

26. The process of claim 19 which further comprises the steps of adjusting the pH of said slurry, filtering said slurry and washing the filter cake after milling said slurry in accordance with step (b).

27. The process of claim 19 which further comprises the step of combining a chemical additive for improving the flow characteristics of said particulate inorganic pigment during drying with said slurry prior to drying said pigment in accordance with step (c).

28. The process of claim 19 wherein said particulate inorganic pigment is separated from said slurry and dried in accordance with step (c) by spray drying said pigment.

29. The process of claim 19 wherein said dispersibility improving agent is in the form of a dry powder and is mixed with said dried particulate inorganic pigment in accordance with step (d) in an amount in the range of from about 0.5% to about 1.5% by weight of said particulate inorganic pigment in said mixture.

30. The process of claim 19 wherein said dispersibility improving agent is coated on said particulate inorganic pigment in an amount in the range of from about 0.5% to about 1.5% by weight of said particulate inorganic pigment.

31. An improved particulate inorganic pigment having enhanced dispersibility in plastic materials comprising a particulate inorganic pigment coated with a dispersibility improving agent comprised of a complex mixture of partially or totally polysaturated and unsaturated fatty acid esters and derivatives thereof, said fatty acid esters having the formula RCOOR¹ wherein R and R¹ each have in the range of from 10 to 24 carbon atoms.

32. The improved particulate inorganic pigment of claim 31 wherein said inorganic pigment is selected from the group consisting of titanium dioxide, zinc sulfide, zinc oxide, iron oxide, lead oxide, aluminum oxide, silicon dioxide, zirconium oxide and chromium oxide.

33. The improved particulate inorganic pigment of claim 31 wherein said inorganic pigment is particulate rutile titanium dioxide pigment.

34. The improved particulate inorganic pigment of claim 33 wherein said particulate titanium dioxide pigment contains co-oxidized alumina in an amount in the range of from about 0.5% to about 1.5% and has a primary particle size in the range of from about 0.1 micron to about 1.0 micron.

35. The improved particulate inorganic pigment of claim 31 wherein said dispersibility improving agent is coated on said pigment in an amount in the range of from about 0.5% to about 1.5% by weight of said pigment.

36. The improved particulate inorganic pigment of claim 31 which further comprises a coating of a metal oxide formed thereon.

37. The improved particulate inorganic pigment of claim 31 which further comprises a coating of a chemical additive for improving the flow properties of said particulate inorganic pigment.

38. The improved particulate inorganic additive of claim 37 wherein said chemical additive is selected from the group consisting of polyalcohols, alkanolamines and organophosphates.
